(19) United States
(12) Patent Application Publication
(10) Pub. No.: US 2022/0113647 A1
(43) Pub. Date: Apr. 14, 2022

(54) ELECTROSTATIC INK COMPOSITION

(71) Applicant: Hewlett-Packard Development Company, L.P., Spring, TX (US)

(72) Inventors: Gil Bar-Haim, Nes Ziona (IL); David SAVELZON, Nes Ziona (IL); Anna RAZGON, Nes Ziona (IL); Asher GAMLIEL, Nes Ziona (IL); Alina GRISHMAN, Nes Ziona (IL); Shmuel BORENSTAIN, Nes Ziona (IL)

(73) Assignee: Hewlett-Packard Development Company, L.P., Spring, TX (US)

(21) Appl. No.: 17/414,895

(22) PCT Filed: Jun. 6, 2019
(86) PCT No.: PCT/US2019/035787

§ 371 Date: Jun. 16, 2021

(51) Int. Cl. G03G 9/12; G03G 9/13; G03G 9/135; C09D 11/037; C09D 11/107; C09D 11/322; C09D 11/38; G03G 15/01

(52) U.S. Cl. CPC G03G 9/122; G03G 9/131; G03G 9/1355; G03G 15/0121; C09D 11/107; C09D 11/322; C09D 11/38; C09D 11/037

(57) ABSTRACT

Described herein is magenta ink composition, comprising a pigment consisting of one or more quinacridone pigments; a resin; and a polymeric amine dispersant having a Total Base Number of at least 300 mg KOH/gram. Also described herein is a method of printing comprising applying the magenta ink composition to a substrate, and a printed substrate comprising the magenta ink composition.

### BACKGROUND

Electrophotographic printing processes, sometimes termed electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, an electrostatic ink composition including charged particles in a liquid carrier can be brought into contact with the selectively charged photoconductive surface. The charged particles adhere to the image areas of the latent image while the background areas remain clean. The image is then transferred to a print substrate (e.g., a polymer substrate) directly or by being first transferred to an intermediate transfer member, which can be a soft swelling blanket, which is often heated to fuse the solid image and evaporate the liquid carrier, and then to the print substrate.

Ink sets for printing can be based on the CMYK color model, with four inks (cyan, magenta, yellow, and key/black), though to access a particular pantone within the color gamut of a particular ink set, it can be necessary to print multiple impressions of a particular ink.

### BRIEF DESCRIPTION OF THE FIGURES

FIG. 1(a) is a graph showing the change in hue of a first magenta ink composition as a function of dispersant concentration;

FIG. 1(b) is a graph showing the change in lightness of a first magenta ink composition as a function of dispersant concentration;

FIG. 1(c) is a graph showing the change in chroma of a first magenta ink composition as a function of dispersant concentration;

FIG. 2(a) is a graph showing the change in hue of a second magenta ink composition as a function of dispersant concentration;

FIG. 2(b) is a graph showing the change in lightness of a second magenta ink composition as a function of dispersant concentration; and

FIG. 2(c) is a graph showing the change in chroma of a magenta ink composition as a function of dispersant concentration.

### DETAILED DESCRIPTION

Before the compositions, methods and related aspects of the disclosure are disclosed and described, it is to be understood that this disclosure is not restricted to the particular process features and materials disclosed herein because such process features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a”, “an”, and “the” include plural referents unless the context clearly dictates otherwise.

As used herein, “liquid carrier”, “carrier”, or “carrier vehicle” refer to the fluid in which the polymer resin, absorber(s), charge directors and/or other additives can be dispersed to form a liquid electrostatic ink or inkjet ink. Liquid carriers can include a mixture of a variety of different agents, such as surfactants, co-solvents, viscosity modifiers, humectants, sequestering agents, buffers, biocides and/or other possible ingredients.

As used herein, “electrostatic ink composition” generally refers to an ink composition, which may be in liquid form, generally suitable for use in an electrostatic printing process, sometimes termed an electrophotographic printing process. The electrostatic ink composition may include chargeable particles suspended in a liquid carrier, which may be as described herein.

As used herein, “co-polymer” refers to a polymer that is polymerized from at least two monomers. However, a copolymer of a particular list of monomer types (e.g., a copolymer of monomer A and monomer B) refers to a copolymer that is polymerized from monomers of those types and no other types of monomer (e.g. an AB polymer).

As used herein, “total base number” (TBN), sometimes simply referred to as base number, may be determined using standard techniques, including, those laid out in ASTM Designation D4739-08, such as Test Method D2896, Test Method D4739, and ASTM Designation D974-08, with Test Method D2896 being used if any discrepancy is shown between test methods, and unless otherwise stated, the test method(s) will be the most recently published at the time of filing this patent application. “mgKOH/g material” indicates “mgKOH per gram of dispersant”. The measurement of TBN of the dispersant can either be on the pure dispersant, or a dispersant in water or a hydrocarbon liquid, such as 60 wt % dispersant in white spirit, e.g. dearomatized white spirit, mineral oil or distillate (e.g. C₁₀₋₂₀ hydrocarbons), and then adjusted as if it had been measured on the pure dispersant.

As used herein, “melt flow rate” generally refers to the extrusion rate of a resin through an orifice of defined dimensions at a specified temperature and load, usually reported as temperature/load, for example, 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

As used herein, “liquid electrostatic(ally) printing” or “liquid electrophotographic(ally) printing” generally refers to the process that provides an image that is transferred from a photo imaging substrate or plate either directly or indirectly via an intermediate transfer member to a print substrate, for example, a polymer substrate. As such, the image is not substantially absorbed into the photo imaging substrate or plate on which it is applied. Additionally, “liquid electrophotographic printers” or “liquid electrostatic printers” generally refer to those printers capable of performing electrophotographic printing or electrostatic printing, as described above. A liquid electrophotographic (LEP) printing process may involve subjecting a liquid electrophotographic ink composition to an electric field, for example, an electric field having a field strength of 1000 V/cm or more, in some examples, 1000 V/mm or more.

As used herein, “LEP image” or “printed LEP image” refer to an image which has been printed, for example, on a print substrate, by liquid electrophotographically printing a LEP ink composition described herein.

As used herein, “NVS” is an abbreviation of the term “non-volatile solids”.

As used herein, the term “about” is used to provide flexibility to a numerical range endpoint by providing that a given value may be a little above or a little below the endpoint. The degree of flexibility of this term can be dictated by the particular variable.

If a standard test is mentioned herein, unless otherwise stated, the version of the test to be referred to is the most recent at the time of filing this patent application.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and subranges within the indicated range. Thus, included in this numerical range are individual values such as 2, 3.5, and 4 and sub-ranges such as from 1-3, from 2-4, and from 3-5, and so on. This same principle applies to ranges reciting a single numerical value. Furthermore, such an interpretation should apply regardless of the breadth of the range or the characteristics being described.

As used herein, unless specified otherwise, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a magenta ink composition, comprising:
a pigment, wherein the pigment consists of one or more quinacridone pigments;
a resin; and
a polymeric amine dispersant having a Total Base Number of at least 300 mg KOH/gram.

In another aspect, there is provided a method of printing comprising:
applying a magenta ink composition to a substrate, wherein the ink composition comprises:
   a pigment, wherein the pigment consists of one or more quinacridone pigments;
   a resin; and
   a polymeric amine dispersant having a Total Base Number of at least 300 mg KOH/gram.

In a further aspect, there is provided a printed substrate comprising:
a substrate; and
a printed magenta ink composition disposed on the substrate;
wherein the printed magenta ink composition comprises:
   a pigment, wherein the pigment consists of one or more quinacridone pigments;
   a resin; and
   a polymeric amine dispersant having a Total Base Number of at least 300 mg KOH/gram.

Magenta ink compositions may be based on quinacridone pigments, which expand the colour gamut into the violet and blue region, but at the expense of the available pantones in the red. To regain the lost pantones it is possible to add a secondary chromophore, though this conversely reduces the number of available pantones in the violet region. It has been found that the use of highly basic polymeric amine dispersants in combination with quinacridone pigments significantly changed the hue of the pigments by several degrees to red, and increased lightness. Thus, the highly basic polymeric amine dispersants with quinacridone pigments enable expansion of the color gamut by adding pantones in the violet area (from the pigment) while preserving pantones in the red area.

### Magenta Ink Composition

The magenta ink composition is suitable for use in a variety of printing processes. In some examples, the magenta ink composition is an electrostatic ink composition. In some examples, the magenta ink composition is an inkjet ink composition. In some examples, the magenta ink composition is an analogue printing composition.

In some examples, the magenta ink composition is an electrostatic ink composition. In some examples, the magenta ink composition may be a dry electrostatic ink composition, also known as a toner. In some examples, the magenta ink composition may be a liquid electrostatic ink composition.

The liquid electrostatic ink may comprise a carrier liquid and a resin, for example a thermoplastic resin, which may be suspended in the carrier liquid. The liquid electrostatic ink composition may comprise a carrier liquid and chargeable particles suspended in the carrier liquid. The chargeable particles may comprise a thermoplastic resin. The thermoplastic resin may comprise a copolymer of an alkylene monomer and an ethylenically unsaturated monomer comprising an epoxide.

The chargeable particles may comprise a thermoplastic resin and the magenta pigment. In some examples, the electrostatic ink composition may comprise a thermoplastic resin and the pigment.

In some examples, the electrostatic ink composition may comprise a thermoplastic resin and a charge director. In some examples, the electrostatic ink composition may comprise a thermoplastic resin, the pigment and a charge director.

In some examples, the electrostatic ink composition may comprise a thermoplastic resin and a charge adjuvant. In some examples, the electrostatic ink composition may comprise a thermoplastic resin, a pigment and a charge adjuvant. In some examples, the electrostatic ink composition may comprise a thermoplastic resin, a charge director and a charge adjuvant. In some examples, the electrostatic ink composition may comprise a thermoplastic resin, a pigment, a charge director and a charge adjuvant.

### Pigment

The magenta ink composition comprises a pigment, wherein the pigment consists of one or more quinacridone pigments. In some examples, the pigment consists of a single quinacridone pigment. In some examples, the pigment consists of two, three or four quinacridone pigments in combination. Unless otherwise stated, references to “pigment” are to one, two, three or four quinacridone pigments, alone or in combination.

Quinacridone pigments have been found to have the highest chroma of the various magenta pigments that are available for use in printing inks, and consist of 5 aromatic rings. Different commercially available quinacridone pigments may contain different functional groups on the aromatic rings. Examples of suitable quinacridone pigments include 5,12-dihydro-quino[2,3-b]acridine-7,14-dione (Pigment Violet 19), 2,9-dimethylquinacridone (Pigment Red 122), 2,9-dichloroquinacridone (Pigment Red 202) and 3,10-dichloroquinacridone (Pigment Red 209). In some examples, the pigment consists of a combination of one or more quinacridone pigments, for example a combination of one or more of Pigment Violet 19, Pigment Red 122, Pigment Red 202 and Pigment Red 209. In some examples, the pigment consists of a primary quinacridone pigment and a secondary quinacridone pigment. In some examples, the primary quinacridone pigment is present in a greater amount than the secondary quinacridone pigment. In some examples, the primary pigment is 2,9-dimethylquinacridone. Commercially available quinacridone pigments include Ink jet Magenta E7B VP 3958, Ink Jet Magenta E02-ECO VP6007 and Cinquasia® Magenta D 4500 J.

In some examples, the pigment particles may have a median particle size (particle diameter) or d₅₀ of 20 μm or less, for example, 15 μm or less, for example, 10 μm or less, for example, 5 μm or less, for example, 4 μm or less, for example, 3 μm or less, for example, 2 μm or less, for example, 1 μm or less, for example, 0.9 μm or less, for example, 0.8 μm or less, for example, 0.7 μm or less, for example, 0.6 μm or less, for example, 0.5 μm or less. Unless otherwise stated, the particle size of the pigment particle and the resin coated pigment particle is determined by using laser diffraction on a Malvern Mastersizer 2000 according to the standard procedure as described in the operating manual.

The pigment may be present in an ink composition in an amount of from 10 wt. % to 80 wt. % of the total amount of solids in the ink composition, in some examples, 10 wt. % to 70 wt. %, in some examples, 10 wt. % to 60 wt. %, in some examples, 10 wt. % to 50 wt. %, in some examples, 10 wt. % to 40 wt. %, in some examples, 10 wt. % to 30 wt. % of the total amount of solids in the ink composition. The pigment may be present in an ink composition in an amount of from 10 wt. % to 80 wt. % of the total amount of solids in the ink composition, in some examples, 15 wt. % to 80 wt. %, in some examples, 15 wt. % to 60 wt. %, in some examples, 15 wt. % to 50 wt. %, in some examples, 15 wt. % to 40 wt. %, in some examples, 15 wt. % to 30 wt. % of the total amount of solids in the ink composition. In some examples, the pigment particle may be present in an ink composition in an amount of at least 20 wt. % of the total amount of resin and pigment, for example, at least 25 wt. % of the total amount of resin and colorant or pigment.

### Resin

In some examples, the magenta ink composition comprises a resin, also referred to herein as a polymer resin.

The resin may comprise a copolymer of an alkylene monomer and a monomer selected from acrylic acid and methacrylic acid. The resin may be referred to as a thermoplastic resin or thermoplastic polymer. In some examples, the polymer may comprise one or more of ethylene or propylene acrylic acid co-polymers; ethylene or propylene methacrylic acid co-polymers; ethylene vinyl acetate co-polymers; co-polymers of ethylene or propylene, and alkyl (e.g. C1 to C5) ester of methacrylic or acrylic acid; co-polymers of ethylene, acrylic or methacrylic acid and alkyl (e.g. C1 to C5) ester of methacrylic or acrylic acid; co-polymers of ethylene or propylene and maleic anhydride; polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate/methacrylic acid/ethylhexylacrylate; ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise one or more polymers having acidic side groups. Examples of polymers having acidic side groups will now be described. The polymer(s) having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer(s) having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise one or more polymers having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer(s) having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer(s) having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN ionomers. The polymer(s) comprising acidic side groups can be co-polymers of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

In some examples, the resin in the liquid electrophotographic ink composition comprises a first resin and the second resin. In some examples, the resin in the liquid electrophotographic ink composition consists of the first resin and the second resin.

The resin may comprise a first resin comprising a copolymer of an alkylene monomer and a methacrylic acid monomer, and a second resin comprising a copolymer of an alkylene monomer and from about 5 wt. % to about 11 wt. % of an acrylic acid monomer.

In some examples, the ratio of the first resin to the second resin is from about 75:25 to about 50:50. In some examples, the ratio of the first resin to the second resin is from about 70:30 to about 55:45, for example, from 65:35 to about 60:40.

In some examples, the resin in the liquid electrophotographic ink composition comprises a first resin, a second resin and a third resin. In some examples, the resin in the liquid electrophotographic ink composition consists of the first resin, the second resin and the third resin.

The resin may comprise a first resin comprising a copolymer of an alkylene monomer and a methacrylic acid monomer, and a second resin comprising a copolymer of an alkylene monomer and an acrylic acid monomer, for example from about 5 wt. % to about 11 wt. % of the acrylic acid monomer.

In some examples, the ratio of the first resin to the second resin to the third resin is from 50:40:10 to 64:34:1. In some examples, the ratio of the first resin to the second resin to the third resin is from 55:39:6 to 60:36:4, for example about 58:39:3.

### First Resin

In some examples, the first resin comprises a copolymer of an alkylene monomer and a methacrylic acid monomer. In some examples, the first resin consists of a copolymer of an alkylene monomer and a methacrylic acid monomer.

In some examples, the alkylene monomer is a C2 to C12 alkylene monomer, in some examples, a C2 to C5 alkylene monomer. In some examples, the alkylene monomer is selected form ethylene and propylene. In some examples, the alkylene monomer is ethylene.

In some examples, the first resin comprises a copolymer of a monomer selected from ethylene and propylene and a methacrylic acid monomer. In some examples, the first resin comprises a copolymer of ethylene and a methacrylic acid monomer.

In some examples, the first resin comprises a copolymer of an alkylene monomer and about 5 wt. % or more of a methacrylic acid monomer, for example, about 6 wt. % or more, about 7 wt. % or more, about 8 wt. % or more, about 9 wt. % or more, about 10 wt. % or more, about 11 wt. % or more, about 12 wt. % or more, about 13 wt. % or more, about 14 wt. % or more, or about 15 wt. % or more of a methacrylic acid monomer. In some examples, the first resin comprises a copolymer of an alkylene monomer and about 15 wt. % or less of a methacrylic acid monomer, for example, about 14 wt. % or less, about 13 wt. % or less, about 12 wt. % or less, about 11 wt. % or less, about 10 wt. % or less, about 9 wt. % or less, about 8 wt. % or less, about 7 wt. % or less, about 6 wt. % or less, or about 5 wt. % or less of a methacrylic acid monomer.

In some examples, the first resin comprises a copolymer of an alkylene monomer, for example, ethylene, and from about 5 wt. % to about 15 wt. % of a methacrylic acid monomer, for example, from about 6 wt. % to about 14 wt. %, from about 7 wt. % to about 14 wt. %, from about 8 wt. % to about 13 wt. %, from about 9 wt. % to about 13 wt. %, from about 10 wt. % to about 12 wt. %, or from about 11 wt. % to about 12 wt. % of a methacrylic acid monomer.

In some examples, the first resin comprises a copolymer of ethylene and 11 wt. % methacrylic acid.

In some examples, the proportion of methacrylic acid in the first resin is comparable to the proportion of acrylic acid in the second resin. In some examples, the amount of methacrylic acid in the copolymer of an alkylene monomer and a methacrylic acid monomer is within 2 wt. % of the amount of acrylic acid in the copolymer of an alkylene monomer and an acrylic acid monomer. In some examples, the amount of methacrylic acid in the copolymer of an alkylene monomer and a methacrylic acid monomer is within 1.5 wt. % of the amount of acrylic acid in the copolymer of an alkylene monomer and an acrylic acid monomer. In some examples, the amount of methacrylic acid in the copolymer of an alkylene monomer and a methacrylic acid monomer is within 1 wt. % of the amount of acrylic acid in the copolymer of an alkylene monomer and an acrylic acid monomer.

In some examples, the first resin has an acidity that is comparable to the acidity of the second resin. In some examples, the first resin may have an acidity that is within 20 mg KOH/g of the acidity of the second resin, for example, within 15 mg KOH/g or within 10 mg KOH/g of the acidity of the second resin.

In some examples, the first resin has a melt flow rate of 120 g/10 min or less, for example, 110 g/10 min or less, 105 g/10 min or less, 100 g/10 min or less, 95 g/10 min or less, 90 g/10 min or less, 85 g/10 min or less, 80 g/10 min or less, 75 g/10 min or less, 70 g/10 min or less, 65 g/10 min or less, 60 g/10 min or less, 55 g/10 min or less, 50 g/10 min or less, 45 g/10 min or less, 40 g/10 min or less, 35 g/10 min or less, 30 g/10 min or less, 25 g/10 min or less, 20 g/10 min or less, 15 g/10 min or less, or 10 g/10 min or less. In some examples, the first resin has a melt flow rate of 10 g/10 min or more, for example, 15 g/10 min or more, 20 g/10 min or more, 25 g/10 min or more, 30 g/10 min or more, 35 g/10 min or more, 40 g/10 min or more, 45 g/10 min or more, 50 g/10 min or more, 55 g/10 min or more, 60 g/10 min or more, 65 g/10 min or more, 70 g/10 min or more, 75 g/10 min or more, 80 g/10 min or more, 85 g/10 min or more, 90 g/10 min or more, 95 g/10 min or more, 100 g/10 min or more, 105 g/10 min or more, 110 g/10 min or more, 115 g/10 min or more, or 120 g/10 min or more. In some examples, the first resin has a melt flow rate of from about 5 g/10 min to 120 g/10 min, 10 g/10 min to 120 g/10 min, 15 g/10 min to 115 g/10 min, 20 g/10 min to 115 g/10 min, 25 g/10 min to 110 g/10 min, 30 g/10 min to 110 g/10 min, 35 g/10 min to 100 g/10 min, 40 g/10 min to 100 g/10 min, 45 g/10 min to 95 g/10 min, 50 g/10 min to 120 g/10 min, 55 g/10 min to 115 g/10 min, 60 g/10 min to 110 g/10 min, 65 g/10 min to 120 g/10 min, 70 g/10 min to 115 g/10 min, 75 g/10 min to 100 g/10 min, 80 g/10 min to 95 g/10 min, 85 g/10 min to 95 g/10 min, or 90 g/10 min to 95 g/10 min. The melt flow rate can be measured by using ASTM D1238 or ISO 1133 at a temperature of 190° C. and using 2.16 kg.

In some examples, the solids of the liquid electrophotographic ink composition comprises at least 30 wt. % first resin, for example, at least 31 wt. %, at least 32 wt. %, at least 33 wt. %, at least 34 wt. %, at least 35 wt. %, at least 36 wt. %, at least 37 wt. %, at least 38 wt. %, at least 39 wt. %, at least 40 wt. %, at least 41 wt. %, at least 42 wt. %, at least 43 wt. %, at least 44 wt. %, at least 45 wt. %, at least 50 wt. %, at least 55 wt. %, or at least 60 wt. % first resin. In some examples, the solids of the liquid electrophotographic ink composition comprises 60 wt. % or less first resin, for example, 55 wt. % or less, 50 wt. % or less, 45 wt. % or less, 44 wt. % or less, 43 wt. % or less, 42 wt. % or less, 41 wt. % or less, 40 wt. % or less, 39 wt. % or less, 38 wt. % or less, 37 wt. % or less, 36 wt. % or less, 35 wt. % or less, 34 wt. % or less, 33 wt. % or less, 32 wt. % or less, 31 wt. % or less, or 30 wt. % or less first resin. In some examples, the solids of the liquid electrophotographic ink composition comprises from about 30 wt. % to about 60 wt. % first resin, for example, from about 31 wt. % to about 55 wt. %, from about 32 wt. % to about 50 wt. %, from about 33 wt. % to about 45 wt. %, from about 34 wt. % to about 44 wt. %, from about 35 wt. % to about 43 wt. %, from about 36 wt. % to about 42 wt. %, from about 37 wt. % to about 41 wt. %, from about 38 wt. % to about 40 wt. %, or from about 39 wt. % to about 60 wt. % first resin.

Examples of suitable resins include the Nucrel™ resins 699, 599, 925, 960 and 2806.

### Second Resin

In some examples, the second resin comprises a copolymer of an alkylene monomer and an acrylic acid monomer, for example from about 5 wt. % to about 11 wt. % of an acrylic acid monomer. In some examples, the second resin consists of a copolymer of an alkylene monomer and from about 5 wt. % to about 11 wt. % of an acrylic acid monomer.

In some examples, the alkylene monomer is a C2 to C12 alkylene monomer, in some examples, a C2 to C5 alkylene monomer. In some examples, the alkylene monomer is selected form ethylene and propylene. In some examples, the alkylene monomer is ethylene.

In some examples, the second resin comprises a copolymer of a monomer selected from ethylene and propylene and an acrylic acid monomer. In some examples, the second resin comprises a copolymer of ethylene and from about 5 wt. % to about 11 wt. % of an acrylic acid monomer.

In some examples, the second resin comprises a copolymer of an alkylene monomer and about 5 wt. % or more of an acrylic acid monomer, for example, about 6 wt. % or more, about 7 wt. % or more, about 8 wt. % or more, about 9 wt. % or more, about 10 wt. % or more, about 11 wt. % of an acrylic acid monomer. In some examples, the second comprises a copolymer of an alkylene monomer and about 11 wt. % or less of an acrylic acid monomer, for example, about 10 wt. % or less, about 9 wt. % or less, about 8 wt. % or less, about 7 wt. % or less, about 6 wt. % or less, or about 5 wt. % of an acrylic acid monomer.

In some examples, the second resin comprises a copolymer of an alkylene monomer, for example, ethylene, and from about 5 wt. % to about 11 wt. % of an acrylic acid monomer, for example, from about 6 wt. % to about 10 wt. %, from about 7 wt. % to about 11 wt. %, from about 8 wt. % to about 11 wt. %, from about 9 wt. % to about 10 wt. % of an acrylic acid monomer.

In some examples, the second resin comprises a copolymer of ethylene and 10 wt. % acrylic acid.

In some examples, the second resin has an acidity of 100 mg KOH/g or less, for example, 95 mg KOH/g or less, 90 mg KOH/g or less, 85 mg KOH/g or less, 80 mg KOH/g or less, or 75 mg KOH/g or less. In some examples, the second resin has an acidity of 50 mg KOH/g or more, 55 mg KOH/g or more, 60 mg KOH/g or more, 65 mg KOH/g or more, 70 mg KOH/g or more, or 75 mg KOH/g or more. In some examples, the second resin has an acidity of from about 50 mg KOH/g to about 100 mg KOH/g, from about 55 mg KOH/g to about 95 mg KOH/g, from about 60 mg KOH/g to about 90 mg KOH/g, from about 65 mg KOH/g to about 85 mg KOH/g, from about 70 mg KOH/g to about 80 mg KOH/g, or from about 70 mg KOH/g to about 75 mg KOH/g.

In some examples, the second resin has a melt viscosity of 15000 poise or less, in some examples, 10000 poise or less, in some examples, 1000 poise or less, in some examples, 100 poise or less, in some examples, 50 poise or less, in some examples 10 poise or less. The melt viscosity can be measured using a rheometer, e.g., a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. In some examples, the viscosity at 140° C. is 1000 centipoise (cP) or less, in some examples, 950 cP or less, 900 cP or less, 875 cP or less, in some examples, 850 cP or less, in some examples, 825 cP or less, in some examples, 800 cP or less, in some examples, 750 cP or less, in some examples, 700 cP or less, in some examples, 650 cP. In some examples, the viscosity at 140° C. is 300 cP or more, in some examples, 400 cP or more, in some examples, 450 cP or more, in some examples, 500 cP or more, in some examples, 550 cP or more, in some examples, 600 cP or more, in some examples, 650 cP or more, in some examples, 700 cP or more, in some example, 750 cP or more, in some examples, 800 cP or more, in some examples, 825 cP or more. In some examples, the viscosity at 140° C. is 300 cP to 1000 cP, in some examples, 300 cP to 950 cP, in some examples, 400 cP to 900 cP, in some examples, 450 cP to 875 cP, in some examples, 550 cP to 850 cP, in some examples, 650 cP to 825 cP, in some examples, 700 cP to 900 cP, in some examples, 750 cP to 850 cP, in some examples, 800 cP to 825 cP.

In some examples, the solids of the liquid electrophotographic ink composition comprises at least 15 wt. % second resin, for example, at least 16 wt. %, at least 17 wt. %, at least 18 wt. %, at least 19 wt. %, at least 20 wt. %, at least 21 wt. %, at least 22 wt. %, at least 23 wt. %, at least 24 wt. %, at least 25 wt. %, at least 26 wt. %, at least 27 wt. %, at least 28 wt. %, at least 29 wt. %, at least 30 wt. %, at least 35 wt. %, or at least 40 wt. % second resin. In some examples, the solids of the liquid electrophotographic ink composition comprises 40 wt. % or less second resin, for example, 35 wt. % or less, 30 wt. % or less, 29 wt. % or less, 28 wt. % or less, 27 wt. % or less, 26 wt. % or less, 25 wt. % or less, 24 wt. % or less, 23 wt. % or less, 22 wt. % or less, 21 wt. % or less, 20 wt. % or less, 19 wt. % or less, 18 wt. % or less, 17 wt. % or less, 16 wt. % or less, or 15 wt. % or less second resin. In some examples, the solids of the liquid electrophotographic ink composition comprises from about 15 wt. % to about 40 wt. % second resin, for example, from about 16 wt. % to about 35 wt. %, from about 17 wt. % to about 30 wt. %, from about 16 wt. % to about 29 wt. %, from about 17 wt. % to about 28 wt. %, from about 18 wt. % to about 27 wt. %, from about 19 wt. % to about 26 wt. %, from about 20 wt. % to about 25 wt. %, from about 21 wt. % to about 24 wt. %, or from about 22 wt. % to about 23 wt. % second resin.

An example of the second resin is A-C™ 580 or A-C™ 540.

### Third Resin

In some examples, the resin comprises a third resin. In some examples, the third resin comprises an acrylate copolymer.

In some examples, the acrylate copolymer is a copolymer of an alkylene monomer and an alkyl (meth)acrylate monomer. The acrylate copolymer comprises at least about 30 wt. % of the alkyl (meth)acrylate monomer by total weight of the acrylate copolymer.

In some examples, the alkylene monomer is ethylene or propylene. In some examples, the alkylene monomer is ethylene.

In some examples, the acrylate copolymer comprises at least about 31 wt. % of the alkyl (meth)acrylate monomer by total weight of the acrylate copolymer, in some examples at least about 32 wt. %, in some examples at least about 33 wt. %, in some examples at least about 34 wt. % and in some examples at least about 35 wt. % of the alkyl (meth)acrylate monomer by total weight of the acrylate copolymer.

In some examples, the acrylate copolymer comprises from about 30 wt. % to about 50 wt. % of the alkyl (meth)acrylate monomer by total weight of the acrylate copolymer, in some examples from about 30 wt. % to about 40 wt. %. In some examples, the acrylate copolymer comprises about 35 wt. % of the alkyl (meth)acrylate monomer by total weight of the acrylate copolymer.

In some examples, the acrylate copolymer comprises about 35 wt. % of the alkyl (meth)acrylate monomer by total weight of the acrylate copolymer, with the remaining component of the acrylate copolymer consisting essentially of, or consisting of, the alkylene monomer.

In some examples, the alkyl (meth)acrylate monomer is a C1-C10 alkyl (meth)acrylate monomer. In some examples, the alkyl (meth)acrylate monomer is a C1, C2, C3, C4, C5, or C6 alkyl (meth)acrylate monomer. In some examples, the alkyl (meth)acrylate monomer is a C1-C4 alkyl (meth)acrylate monomer (e.g. C1, C2, C3 or C4). In some examples, the alkyl (meth)acrylate monomer is a butyl (meth)acrylate monomer.

In some examples, the alkyl (meth)acrylate monomer is a alkyl acrylate monomer, for example a C1-C10 alkyl acrylate monomer. In some examples, the alkyl acrylate monomer is a C1, C2, C3, C4, C5, or C6 alkyl acrylate monomer. In some examples, the alkyl acrylate monomer is a C1-C4 alkyl acrylate monomer (e.g. C1, C2, C3 or C4). In some examples, the alkyl acrylate monomer is a butyl acrylate monomer. Mixtures of alkyl isomers are also possible. For example, when the alkyl is butyl, it can be any one of normal, iso- and/or tert-butyl.

In some examples, the third resin is an acrylate copolymer, for example a copolymer of ethylene and butyl acrylate. In some examples, the acrylate copolymer comprises about 35 wt. % butyl acrylate.

A suitable commercially available acrylate copolymer is Elvaloy® AC 34035 (Dupont).

In some examples, the acrylate copolymer constitutes at least about 1 wt. % by total weight of the resin, for example at least about 1.5 wt. %, or at least about 2 wt. % total weight of the resin. In some examples, the acrylate copolymer constitutes from about about 0.1 wt. % to about 5 wt. % by total weight of the resin, for example from about 1.5 wt. % to about 5 wt. %, or from about 2 wt. % to about 4 wt. % by total weight of the resin.

The polymer resin can constitute about 5% to 90%, in some examples, about 50% to 80%, by weight of the solids of the liquid electrophotographic composition and/or the electrostatic ink layer printed on the substrate. The resin can constitute about 60% to 95%, in some examples, about 70% to 95%, by weight of the solids of the liquid electrophotographic composition and/or the electrostatic ink layer printed on the substrate.

### Polymeric Amine Dispersant

The magenta ink composition comprises a polymeric amine dispersant having a total base number (TBN) greater than about 300 mgKOH/g material. The amine-containing basic dispersant may be present in the ink composition in an amount of up to about 10 wt. % by weight of the quinacridone pigment. The polymeric amine dispersant having a TBN greater than about 300 mgKOH/g material may be termed an amine-containing dispersant or a basic polymeric dispersant herein.

In some examples, the basic polymeric dispersant comprises a basic anchor group, that is, an amine group. In some examples, each basic polymeric dispersant molecule comprises a multi amine anchor group or a single amine anchor group, in some examples each basic polymeric dispersant molecule comprises a multi amine anchor group. In some examples, the basic polymeric dispersant comprises a polyester. In some examples, the basic polymeric dispersant comprises a polyester and an amine anchor group. In some examples, the basic polymeric dispersant comprises a polyester terminated by an amine containing group bound to the polyester through an amide linkage. In some examples, the polymeric amine dispersant comprises a copolymer having pendant stearic acid groups.

In some examples, the basic polymeric dispersant comprises a co-polymer. In some examples, the basic polymeric dispersant comprises a block co-polymer having multiple anchor groups, for example an ABA block co-polymer or a BAB block co-polymer or a random copolymer. In some examples, the polymeric dispersant comprises a comb co-polymer.

In some examples, the polymeric amine dispersant is Solplus® P6000 (available from Lubrizol), which has a TBN of about 400 mgKOH/g material.

In some examples, the amine-containing basic dispersant has a total base number (TBN) of at least about 300 mgKOH/g material, in some examples, a TBN of at least about 310 mgKOH/g material, in some examples, a TBN of at least about 320 mgKOH/g material, in some examples, a TBN of at least about 330 mgKOH/g material, in some examples, a TBN of at least about 340 mgKOH/g material, in some examples, 350 mgKOH/g material, in some examples a TBN of at least about 360 mgKOH/g material, in some examples a TBN of at least about 370 mgKOH/g material, in some examples a TBN of at least about 380 mgKOH/g material, in some examples a TBN of at least about 390 mgKOH/g material, in some examples a TBN of about 400 mgKOH/g material. In some examples, amine-containing basic dispersant has a TBN of about 450 mgKOH/g material or less, in some examples a TBN of about 440 mgKOH/g material or less, in some examples a TBN of about 430 mgKOH/g material or less, in some examples a TBN of about 420 mgKOH/g material or less, in some examples a TBN of about 410 mgKOH/g material or less. In some examples the basic dispersant has a total base number (TBN) of from about 300 mgKOH/g material to about 450 mgKOH/g material, in some examples from about 310 mgKOH/g material to about 445 mgKOH/g material, in some examples from about 320 mgKOH/g material to about 440 mgKOH/g material, in some examples from about 330 mgKOH/g material to about 435 mgKOH/g material, in some examples from about 340 mgKOH/g material to about 430 mgKOH/g material, in some examples from about 350 mgKOH/g material to about 425 mgKOH/g material, in some examples from about 355 mgKOH/g material to about 420 mgKOH/g material, in some examples from about 360 mgKOH/g material to about 415 mgKOH/g material, in some examples from about 365 mgKOH/g material to about 410 mgKOH/g material, in some examples from about 370 mgKOH/g material to about 405 mgKOH/g material, in some examples from about 375 mgKOH/g material to about 405 mgKOH/g material, in some examples from about 380 mgKOH/g material to about 400 mgKOH/g material, in some examples from about 385 mgKOH/g material to about 450 mgKOH/g material, in some examples from about 390 mgKOH/g material to about 445 mgKOH/g material, in some examples from about 395 mgKOH/g material to about 405 mgKOH/g material.

In some examples, the amine-containing basic dispersant has a total base number (TBN) of from about 300 mgKOH/g material to about 500 mgKOH/g material, in some examples from about 380 mgKOH/g material to about 420 mgKOH/g material, in some examples about 400 mgKOH/g material.

In some examples, the amine-containing basic dispersant has a total base number (TBN) of less than about 500 mgKOH/g material, in some examples less than about 450 mgKOH/g material, in some examples less than about 425 mgKOH/g material, in some examples less than about 420 mgKOH/g material, in some examples less than about 410 mgKOH/g material.

In some examples, the dispersant has a weight average molecular weight (MW) of about 2 kg/mol or more, for example, about 2.1 kg/mol or more, about 2.2 kg/mol or more, about 2.3 kg/mol or more, about 2.4 kg/mol or more, about 2.5 kg/mol or more, about 2.6 kg/mol or more, about 2.7 kg/mol or more, about 2.8 kg/mol or more, about 2.9 kg/mol or more, or about 3 kg/mol. In some examples, the dispersant has a weight average molecular weight (MW) of about 5 kg/mol or less, for example, about 4.9 kg/mol or less, about 4.8 kg/mol or less, about 4.7 kg/mol or less, about 4.6 kg/mol or less, about 4.5 kg/mol or less, about 4.4 kg/mol or less, about 4.3 kg/mol or less, about 4.2 kg/mol or less, about 4.1 kg/mol or less, or about 4 kg/mol. In some examples, the dispersant has a weight average molecular weight (MW) of from about 2 kg/mol to about 5 kg/mol, for example, from about 2.1 kg/mol to about 4.9 kg/mol, from about 2.2 kg/mol to about 4.8 kg/mol, from about 2.3 kg/mol to about 4.7 kg/mol, from about 2.4 kg/mol to about 4.6 kg/mol, from about 2.5 kg/mol to about 4.5 kg/mol, from about 2.6 kg/mol to about 4.4 kg/mol, from about 2.7 kg/mol to about 4.3 kg/mol, from about 2.8 kg/mol to about 4.2 kg/mol, from about 2.9 kg/mol to about 4.1 kg/mol, or from about 3 kg/mol to about 4 kg/mol. In some examples, the dispersant may have a weight average molecular weight of about 3.5 kg/mol.

In some examples, the polymeric amine dispersant may be present as a solution or dispersion of the active dispersant in a carrier fluid prior to be added to the ink composition. In some examples, the polymeric amine dispersant may be present as a 50% actives solution in a carrier fluid, such as a mineral oil or dipropylene glycol.

In some examples, the ink composition comprises a polymeric amine dispersant in an amount up to about 50 wt. % by weight of the pigment, for example up to about 40 wt. %, up to about 30 wt. %, up to about 20 wt. % by weight of the pigment, based on the amount of active dispersant.

In some examples, the ink composition comprises polymeric amine dispersant in an amount of at least about 1 wt. % by weight of the pigment, for example at least about 5 wt. %, at least about 10 wt. %, at least about 15 wt. %, at least about 20 wt. %, at least about 30 wt. %, at least about 40 wt. %, at least about 50 wt. % by weight of the pigment, based on the amount of active dispersant.

In some examples, the ink composition comprises polymeric amine dispersant in an amount in the range of about 1 wt. % to about 50 wt. % by weight of the pigment, for example, about 5 wt. % to about 40 wt. %, about 10 wt. % to about 30 wt. %, about 15 wt. % to about 25 wt. % by weight of the pigment, based on the amount of active dispersant.

The polymeric amine dispersant may constitute from 0.01 wt. % to 10 wt. % of the total solids of the ink composition, in some examples 1 wt. % to 9 wt. % of the total solids of the ink composition, in some examples 1.5 wt. % to 8 wt. % of the total solids of the ink composition, in some examples 2 wt. % to 7 wt. % of the total solids of the ink composition, in some examples 3 wt. % to 6 wt. % of the total solids of the ink composition, in some examples 4 wt. % to 5 wt. % of the total solids of the ink composition.

In some examples, the polymeric amine dispersant is present in an amount to provide an agent on weight of pigment (AOWP) percentage of from 2% to 30%, for example from 3% to 25%, for example from 4% to 25%, for example from 5% to 20%.

### Liquid Carrier

In some examples, for example, when printing, the electrostatic ink composition comprises a liquid carrier. Generally, the liquid carrier can act as a dispersing medium for the other components in the electrostatic ink composition. For example, the liquid carrier can comprise or be a hydrocarbon, silicone oil, vegetable oil, or the like. The liquid carrier can include, but is not limited to, an insulating, non-polar, non-aqueous liquid that can be used as a medium for toner particles. The liquid carrier can include compounds that have a resistivity in excess of about 10⁹ ohm·cm. The liquid carrier may have a dielectric constant below about 5, in some examples, below about 3. The liquid carrier can include, but is not limited to, hydrocarbons. The hydrocarbon can include, but is not limited to, an aliphatic hydrocarbon, an isomerized aliphatic hydrocarbon, a branched chain aliphatic hydrocarbon, an aromatic hydrocarbon, and combinations thereof. Examples of the liquid carrier include, but are not limited to, aliphatic hydrocarbons, isoparaffinic compounds, paraffinic compounds, dearomatized hydrocarbon compounds, and the like. In particular, the liquid carrier can include, but is not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™)

Before electrostatic printing, the liquid carrier can constitute about 20% to 99.5% by weight of the electrostatic ink composition, in some examples, 50% to 99.5% by weight of the electrostatic ink composition. Before printing, the liquid carrier may constitute about 40 to 90% by weight of the electrostatic ink composition. Before printing, the liquid carrier may constitute about 60% to 80% by weight of the electrostatic ink composition. Before printing, the liquid carrier may constitute about 90% to 99.5% by weight of the electrostatic ink composition, in some examples, 95% to 99% by weight of the electrostatic ink composition.

The electrostatic ink, when electrostatically printed, may be substantially free from liquid carrier. In an electrostatic printing process and/or afterwards, the liquid carrier may be removed, for example, by an electrophoresis processes during printing and/or evaporation, such that substantially just solids are transferred to the substrate. Substantially free from liquid carrier may indicate that the ink printed on the substrate contains less than 5 wt. % liquid carrier, in some examples, less than 2 wt. % liquid carrier, in some examples, less than 1 wt. % liquid carrier, in some examples, less than 0.5 wt. % liquid carrier. In some examples, the ink printed on the substrate is free from liquid carrier.

### Charge Director

In some examples, the electrostatic ink composition includes a charge director.

The charge director may be added in order to impart and/or maintain sufficient electrostatic charge on ink particles during electrostatic printing, which may be chargeable particles comprising a thermoplastic resin comprising a copolymer of an alkylene monomer and an ethylenically unsaturated monomer comprising an epoxide. The charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, and the like. The charge director can be selected from, but is not limited to, oil-soluble petroleum sulfonates (e.g., neutral Calcium Petronate™, neutral Barium Petronate™, and basic Barium Petronate™), polybutylene succinimides (e.g., OLOA™ 1200 and Amoco 575), and glyceride salts (e.g., sodium salts of phosphated mono- and diglycerides with unsaturated and saturated acid substituents), sulfonic acid salts including, but not limited to, barium, sodium, calcium, and aluminium salts of sulfonic acid. The sulfonic acids may include, but are not limited to, alkyl sulfonic acids, aryl sulfonic acids, and sulfonic acids of alkyl succinates. The charge director can impart a negative charge or a positive charge on the chargeable particles of an electrostatic ink composition.

In some examples, the electrostatic ink composition comprises a charge director comprising a simple salt. Simple salts are salts that do not form micelles by themselves, although they may form a core for micelles with a micelle forming salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F⁻, ClO₄⁻, and TiO₃⁴⁻, or from any sub-group thereof. The simple salt may be selected from CaCO₃, Ba₂TiO₃, Al₂(SO₄) Al(NO₃)₃, Ca₃(PO₄)₂, BaSO₄, BaHPO₄, Ba₂(PO₄)₃, CaSO₄ (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

The charge director may include at least one of (i) soya lecithin, (ii) a barium sulfonate salt, such as basic barium petronate (BBP), and (iii) an isopropyl amine sulfonate salt. Basic barium petronate is a barium sulfonate salt of a C21-26 hydrocarbon alkyl, and can be obtained, for example, from Chemtura. An example isopropyl amine sulfonate salt is dodecyl benzene sulfonic acid isopropyl amine, which is available from Croda.

In some examples, the electrostatic ink composition comprises a charge director comprising a sulfosuccinate salt of the general formula MAₙ, wherein M is a metal, n is the valence of M, and A is an ion of the general formula (I):

[R¹—O—C(O)CH₂CH(SO₃)C(O)—O—R²1 (I)

wherein each of R¹ and R² is an alkyl group.

The sulfosuccinate salt of the general formula MAₙ is an example of a micelle forming salt. The charge director may be substantially free of or free of an acid of the general formula HA, where A is as described above. The charge director may include micelles of said sulfosuccinate salt enclosing at least some of the nanoparticles. The charge director may include at least some nanoparticles having a size of 200 nm or less, and/or, in some examples, 2 nm or more.

In the formula [R¹—O—C(O)CH₂CH(SO₃)C(O)—O—R²], in some examples, each of R¹ and R² is an aliphatic alkyl group. In some examples, each of R¹ and R² independently is a C3 to C30 alkyl, for example, C6-25 alkyl, C10 to C20 alkyl or C11 to C15 alkyl. In some examples, R¹ and R² are both C13 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same or different. In some examples, R¹ and R² are the same. In some examples, at least one of R¹ and R² is C₁₃H₂₇. In some examples, M is Na, K, Cs, Ca, or Ba.

In some examples, the charge director constitutes about 0.001 to 20% by weight, in some examples, 0.01 to 20% by weight, in some examples, 0.01 to 10% by weight, in some examples, 0.01 to 1% by weight of the solids of the electrostatic ink composition. In some examples, the charge director constitutes about 0.001 to 0.15% by weight of the solids of the electrostatic ink composition, in some examples, 0.001 to 0.15%, in some examples, 0.001 to 0.02% by weight of the solids of the electrostatic ink composition, in some examples, 0.1 to 2% by weight of the solids of the electrostatic ink composition, in some examples, 0.2 to 1.5% by weight of the solids of the electrostatic ink composition, in some examples, 0.1 to 1% by weight of the solids of the electrostatic ink composition, in some examples, 0.2 to 0.8% by weight of the solids of the electrostatic ink composition. In some examples, the charge director is present in an amount of at least 1 mg of charge director per gram of the liquid electrostatic ink composition (which will be abbreviated to mg/g), in some examples, at least 2 mg/g, in some examples, at least 3 mg/g, in some examples, at least 4 mg/g, in some examples, at least 5 mg/g. In some examples, the charge director is present in an amount of from 1 mg to 200 mg of charge director per gram of the liquid electrostatic ink composition (which will be abbreviated to mg/g), in some examples, from 1 mg/g to 150 mg/g, in some examples, from 1 mg/g to 100 mg/g, in some examples, from 1 mg/g to 50 mg/g, in some examples, from 1 mg/g to 20 mg/g, in some examples, from 3 mg/g to 20 mg/g, in some examples, from 3 mg/g to 15 mg/g, in some examples, from 5 mg/g to 10 mg/g.

In some examples, a sulfosuccinate salt based charge director may provide better charging stability than a charge director containing an amine (for example, the charge director comprising a mixture of soya lecithin, a barium sulfonate salt and an isopropyl amine sulfonate salt), thus prolonging the lifespan of the charged electrostatic ink composition. In some examples, the charging stability is not affected by the presence of an amine in the charge director.

### Charge Adjuvant

In some examples, the electrostatic ink composition includes a charge adjuvant.

A charge adjuvant may promote charging of the chargeable particles when a charge director is present in the electrostatic ink composition during printing. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminium di- or tristearate. The charge adjuvant may be present in an amount of about 0.1 to 5% by weight, in some examples, about 0.1 to 1% by weight, in some examples, about 0.3 to 0.8% by weight of the solids of the electrostatic ink composition, in some examples, about 1 to 3% by weight of the solids of the electrostatic ink composition, in some examples, about 1.5 to 2.5% by weight of the solids of the electrostatic ink composition.

In some examples, the electrostatic ink composition further includes, for example, as a charge adjuvant, a salt of a multivalent cation and a fatty acid anion. The salt of a multivalent cation and a fatty acid anion can act as a charge adjuvant. The multivalent cation may, in some examples, be a divalent or a trivalent cation. In some examples, the multivalent cation is selected from Group 2, transition metals, Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C8 to C26 fatty acid anion, in some examples, a C14 to C22 fatty acid anion, in some examples, a C16 to C20 fatty acid anion, in some examples, a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt. % to 5 wt. % of the solids of the electrostatic ink composition, in some examples, in an amount of 0.1 wt. % to 2 wt. % of the solids of the electrostatic ink composition, in some examples, in an amount of 0.1 wt. % to 2 wt. % of the solids of the electrostatic ink composition, in some examples, in an amount of 0.3 wt. % to 1.5 wt. % of the solids of the electrostatic ink composition, in some examples, about 0.5 wt. % to 1.2 wt. % of the solids of the electrostatic ink composition, in some examples, about 0.8 wt. % to 1 wt. % of the solids of the electrostatic ink composition, in some examples, about 1 wt. % to 3 wt. % of the solids of the lectrostatic ink composition, in some examples, about 1.5 wt. % to 2.5 wt. % of the solids of the electrostatic ink composition.

### Additives

The magenta ink composition whether it is formulated as an electrostatic ink composition or an inkjet ink composition may include an additive or a plurality of additives. The additive or plurality of additives may be added at any stage of the method of producing the ink composition. The additive or plurality of additives may be selected from a wax, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, for example, from an intermediate transfer member, which may be a heated blanket.

### Method of Producing the Magenta Ink Composition

The method of producing a magenta ink composition may comprise combining a resin, a pigment consisting of one or more quinacridone pigments, and a polymeric amine dispersant.

In some examples, the method comprises combining the pigment consisting of one or more quinacridone pigments, and the polymeric amine dispersant with a liquid carrier to form pigment particles, before adding the resin to the combined pigment and polymeric amine dispersant.

In some examples, combining the pigment and the polymeric amine dispersant comprises grinding the pigment and the polymeric amine dispersant.

In some examples, the polymeric amine dispersant is a liquid or is in the form of a solution and is combined with the pigment to form a slurry before addition of the resin. In some examples, the polymeric amine dispersant is a liquid or is in solution form and is ground with the pigment to form a slurry before addition of the resin, which may be followed by further grinding. In some examples, the amine-containing basic dispersant is a solid and is ground with the colorant and the resin (e.g., without first combining the amine-containing basic dispersant with the colorant).

In some examples, the method comprises adding a charge director to the ink composition. In some examples, the method comprises adding a charge adjuvant to the ink composition. The charge adjuvant may be added to the ink composition before, during or after the pigment, the polymeric amine dispersant and the resin are combined.

In some examples, the method comprises combining the polymeric amine dispersant and the pigment in amounts to provide an agent on weight of pigment (AOWP) percentage of from 2% to 30%, for example from 3% to 25%, for example from 4% to 25%, for example from 5% to 20%. It will be understood that AOWP percentage refers to the effective amount of active dispersant on pigment based on pigment surface area. For example, a dosage of 2 mg active dispersant on weight of pigment is the pigment surface area divided by 5.

In some examples, the method may comprise suspending a resin in a carrier liquid before adding it to the pigment. In some examples, the method may comprise suspending a first resin, a second resin and a third resin in a carrier liquid. In some examples, the electrophotographic ink comprises chargeable particles comprising a first resin, a second resin and a third resin. In some examples, the method may comprise suspending chargeable particles comprising a first resin, a second resin and a third resin in a carrier liquid.

In some examples, the method may comprise dispersing a first resin, a second resin and a third resin in a carrier liquid. In some examples, the method may comprise dispersing chargeable particles comprising a first resin, a second resin and a third resin in a carrier liquid.

In some examples, the method comprises combining a resin (for example, the first resin) with the carrier liquid and subsequently adding the other resin (for example, the second resin and the third resin). In some examples, the method comprises combining a resin (for example, the first resin) with the carrier liquid to form a paste and subsequently adding the other resin (for example, the second resin and the third resin). In some examples, the resin and the carrier liquid are combined and heated to an elevated temperature before adding the other resin(s), which may have also been heated to an elevated temperature. In some examples, the resin and the carrier liquid are combined and heated to a temperature above the melting point of the resin before adding the other resin(s), which may have also been heated to a temperature above its melting point. In some examples, the resin and carrier liquid are combined and heated until the resin has melted and/or dissolved in the carrier liquid before adding the other resin(s). In some examples, adding the other resin(s) to the combined resin and carrier liquid comprises mixing the other resin with the combined resin and carrier liquid.

The melting point of the resin may be determined by differential scanning calorimetry, for example, using ASTM D3418.

In some examples, the resin and the carrier liquid are combined and heated to a temperature of at least 70° C., for example, at least 80° C., for example, at least 90° C., for example, at least 100° C., for example, at least 110° C., for example, at least 120° C., for example, 130° C., for example, to melt the resin. In some examples, an other resin is heated before being added to the combined resin and carrier liquid. In some examples, an other resin is heated to at least 30° C., in some examples, at least 40° C., in some examples, at least 45° C., in some examples, at least 50° C. before being added to the combined resin and carrier liquid. In some examples, an other resin is heated to 100° C. or less, in some examples, 90° C. or less, in some examples, 80° C. or less, in some examples, 75° C. or less, in some examples, 70° C. or less, in some examples, 60° C. or less before being added to the combined resin and carrier liquid. In some examples, an other resin is heated to reduce the viscosity of the other resin before being added to the first resin and the carrier liquid.

In some examples, the method comprises combining the first resin with the carrier liquid to form a first composition; combining the second resin with the carrier liquid to form a second composition; and combining the third resin with the carrier liquid to form a third composition and subsequently combining the first composition, the second composition and the third composition with the pigment and dispersant to form a magenta ink composition. In some examples, the method comprises combining the first resin with the carrier liquid to form a first paste; combining the second resin with the carrier liquid to form a second paste; combining the third resin with the carrier liquid to form a third paste; and subsequently combining the first paste, the second paste and the third paste with the pigment and dispersant to form a magenta ink composition. In some examples, the first resin and the carrier liquid are combined and heated to an elevated temperature to form a first heated composition; the second resin and the carrier liquid are combined and heated to an elevated temperature to form a second heated composition; the third resin and the carrier liquid are combined and heated to an elevated temperature to form a third heated composition; and subsequently the first heated composition, the second heated composition and the third heated composition are combined. In some examples, the first resin and the carrier liquid are combined and heated to a temperature above the melting point of the first resin to form a first heated composition; the second resin and the carrier liquid are combined and heated to a temperature above the melting point of the second resin to form a second heated composition; the third resin and the carrier liquid are combined and heated to a temperature above the melting point of the third resin to form a third heated composition; and subsequently the first heated composition, the second heated composition and the third heated composition are combined. In some examples, the first composition, the second composition and the third heated composition are heated to the same temperature, which may be a temperature above the melting temperature of all of the resins.

In some examples, the method comprises mixing the first resin, the second resin and the third resin together and then combining the mixture of the resins with the carrier liquid.

In some examples, the first resin, the second resin and the third resin are combined with the carrier liquid and subsequently heated to an elevated temperature. In some examples, the first resin, the second resin and the third resin are combined with the carrier liquid and subsequently heated to a temperature above the melting point of at least one, optionally all, of the resins. In some examples, the first resin, the second resin and the third resin are combined with the carrier liquid and subsequently heated to a temperature of at least 70° C., for example, at least 80° C., for example, at least 90° C., for example, at least 100° C., for example, at least 110° C., for example, at least 120° C., for example, 130° C., for example, to melt at least one, optionally all, of the resins. In some examples, the combined first resin, second resin, third resin and carrier liquid are heated until all of the resins have melted and/or dissolved in the carrier liquid.

In some examples, the method of producing an ink composition comprises combining a first resin, a second resin, a third resin and a carrier liquid.

In some examples, the chargeable particles comprise the first resin, the second resin and the third resin.

Melting and/or dissolving a resin (or resins) in the carrier liquid may result in the carrier fluid appearing clear and homogeneous. In some examples, the resin (or resins) and carrier liquid are heated before, during or after mixing.

In some examples, the resin (or resins) and the carrier liquid are mixed at a mixing rate of 1000 rpm or less, for example 500 rpm or less, for example, 400 rpm or less, for example, 300 rpm or less, for example, 200 rpm or less, for example, 100 rpm or less, for example, 75 rpm or less, for example, 50 rpm. In some examples, mixing may continue until melting and/or dissolution of the resin (or resins) in the carrier liquid is complete.

In some examples, after combining and heating the resins and the carrier liquid, the mixture is cooled to a temperature below the melting point of the resins, for example, to room temperature. In some examples, the chargeable particles are removed from the carrier liquid and re-dispersed in a new portion of carrier liquid, which may be the same or a different carrier liquid.

In some examples, the method comprises adding the combined first resin, second resin, third resin and carrier liquid to the pigment and dispersant. In some examples, the method comprises grinding the pigment, dispersant and the resins in the presence of the carrier liquid to form a paste. In some examples, the method comprises heating and mixing the pigment, dispersant and the resins in the presence of the carrier liquid to form a paste.

In some examples, the method comprises adding a charge adjuvant to the combined first resin, second resin, third resin, pigment, dispersant and carrier liquid and optionally grinding. In some examples, the method comprises adding a charge adjuvant and optionally grinding.

In some examples, the method comprises grinding at a grinding speed of at least 50 rpm. In some examples, the method comprises grinding at a grinding speed of up to about 600 rpm. In some examples, the method comprises grinding for at least 1 h, in some examples, for at least 2 h. In some examples, the method comprises grinding for up to about 12 h. In some examples, the method comprises grinding at a temperature of at least about 30° C., for example, at least about 35° C., for example, at least about 40° C., for example, at least about 50° C. In some examples, the method comprises grinding at a temperature of at least about 50° C. for a first time period, in some examples, for at least 1 h, in some examples, for at least 1.5 h and then reducing the temperature to a temperature of at least 30° C., in some examples, at least 35° C. and continuing grinding for at least 5 h, in some examples, at least 9 h, in some examples, at least 10 h.

In some examples, the method comprises adding a charge director to the combined first pigment, dispersant, first resin, second resin, third resin, and carrier liquid.

### Method of Printing

In an aspect, there is provided a method of printing, comprising:
applying a magenta ink composition to a substrate, wherein the ink composition comprises:
   a pigment, wherein the pigment consists of one or more quinacridone pigments;
   a resin; and
   a polymeric amine dispersant having a Total Base Number of at least 300 mg KOH/gram.

The magenta ink composition may be as described above.

In some examples, the method of printing may comprise printing a plurality of different ink compositions to form an image on a print substrate, at least one of which comprises a magenta ink composition as described above. In some examples, the method of printing may be a method of electrostatic printing.

In some examples, the method of printing may comprise printing a magenta ink composition as described above, and further comprise printing a black ink composition, a cyan ink composition, and a yellow ink composition.

In some examples, the method of printing may comprise liquid electrostatically printing the magenta ink composition onto a substrate by contacting the ink composition with a latent electrostatic image on a surface to create a developed image and transferring the developed image to a substrate, in some examples, via an intermediate transfer member.

In some examples, the surface on which the (latent) electrostatic image is formed or developed may be on a rotating member, e.g., in the form of a cylinder. The surface on which the (latent) electrostatic image is formed or developed may form a part of a photo imaging plate (PIP). The method may involve passing the ink composition between a stationary electrode and a rotating member, which may be a member having the surface having the (latent) electrostatic image thereon or a member in contact with the surface having the (latent) electrostatic image thereon. A voltage is applied between the stationary electrode and the rotating member, such that particles adhere to the surface of the rotating member. The intermediate transfer member, if present, may be a rotating flexible member, which may be heated, e.g., to a temperature of from 80 to 160° C.

The substrate may be any suitable substrate. The substrate may be any suitable substrate capable of having an image printed thereon. The substrate may include a material selected from an organic or inorganic material. The material may include a natural polymeric material, e.g., cellulose. The material may include a synthetic polymeric material, e.g., a polymer formed from alkylene monomers, including, for example, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g., a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic print substrate such as paper. The cellulosic print substrate is, in some examples, a coated cellulosic print. In some examples, a primer may be coated onto the print substrate, before the liquid electrostatic ink composition is printed onto the print substrate.

In some examples, the substrate comprises any suitable textile or fabric substrate. In some examples, the textile or fabric substrate may be a network of natural or synthetic fibres. The fabric substrate may be woven or non-woven. The textile or fabric substrate may be formed of yarns, for example, spun threads or filaments, which may be natural or synthetic material or a combination thereof. The textile or fabric substrate may include substrates that have fibres that may be natural and/or synthetic. The substrate may comprise any textile, fabric material, fabric clothing, or other fabric product onto which it is desired to apply printed matter. The term “textile” includes, by way of example, cloth, fabric material, fabric clothing or other fabric products. The textile substrate may have warp and weft yarns. The terms “warp” and “weft” refer to weaving terms that have their ordinary meaning in the textile arts, that is, warp refers to lengthwise or longitudinal yarns on a loom whereas weft refers to crosswise or transverse yarns on a loom. The textile substrate may be woven, non-woven, knitted, tufted, crocheted, knotted, and/or have a pressed structure.

In some examples, the substrate may include a metal, which may be in sheet form. In some examples, the substrate may comprise a metallic foil or a metallized substrate. In some examples, the substrate may comprise an aluminium foil. In some examples, the substrate may comprise a metallized paper (i.e., paper having a metal layer thereon) or a metallized plastic substrate (i.e., a plastic substrate having a metal layer thereon). The metal may be selected from or made from, for example, aluminium (Al), silver (Ag), tin (Sn), copper (Cu), or mixtures thereof.

In some examples, the substrate is a polymer substrate. In some examples, the polymer substrate may be a copolymer. In some examples, the polymer substrate may be a polymer formed from alkylene monomers. In some examples, the polymer substrate may comprise an acrylic substrate. In some examples, the polymer substrate comprises acrylic, polyethylene (PE), linear low density polyethylene (LLDPE), low density polyethylene (LDPE), medium density polyethylene (MDPE), high density polyethylene (HDPE), polypropylene (PP), cast polypropylene (cPP), biaxially oriented polypropylene (BOPP), polyamide (PA), oriented polyamide (OPA), or polyethylene terephthalate (PET).

In some examples, the substrate may comprise a plurality of layers of material, in some examples, a plurality of layers of material laminated together. In some examples, the substrate may comprise a plurality of layers of material selected from polymeric materials (e.g., polymeric materials selected form PE, LLDPE, MDPE, PP, cPP, BOPP, PA, OPA and PET), metallic materials (e.g., metallic foils such as aluminium foil, or metallized substrates such as metallized-PET or metallized BOPP), paper and combinations thereof. In some examples, the substrate comprises a plurality of layers of polymeric material (such as a combination of layers selected from PE, LLDPE, MDPE, PP, BOPP, PET and OPA) laminated together.

In some examples, the substrate comprises polypropylene and the polypropylene is corona treated before the electrostatic ink composition is electrostatically printed on the surface of the polypropylene.

In some examples, the substrate comprises polyethylene terephthalate and no corona treatment is used before the electrostatic ink composition is electrostatically printed on the surface of the polypropylene.

In some examples, the substrate has a thickness of 300 μm or less, for example, 250 μm or less, 200 μm or less, 150 μm or less, 100 μm or less, 90 μm or less, 80 μm or less, 70 μm or less, 60 μm or less, 50 μm or less, 40 μm or less, 30 μm or less, 20 μm or less, or 15 μm or less. In some examples, the substrate has a thickness of 15 μm or more, for example, 20 μm or more, 30 μm or more, 40 μm or more, 50 μm or more, 60 μm or more, 70 μm or more, 80 μm or more, 90 μm or more, or 100 μm or more. In some examples, the substrate has a thickness of 15 μm to 100 μm, for example, 20 μm to 90 μm, 30 μm to 80 μm, 40 μm to 70 μm, or 50 μm to 50 μm.

### Printed Substrate

In some examples, there is provided a printed substrate comprising
a substrate; and
a printed magenta ink composition disposed on the substrate;
wherein the printed magenta ink composition comprises:
   a pigment, wherein the pigment consists of one or more quinacridone pigments;
   a resin; and
   a polymeric amine dispersant having a Total Base Number of at least 300 mg KOH/gram.

In some examples, the substrate and magenta ink composition are as described above.

### Examples

The following illustrates examples of the methods and other aspects described herein. Thus, these Examples should not be considered as limitations of the present disclosure, but are merely in place to teach how to make examples of the present disclosure.

### Materials

### Resins

Nucrel™ 699: a copolymer of ethylene and methacrylic acid, with nominally 11 wt. % methacrylic acid; available from DuPont™

A-C™ 580: a copolymer of ethylene and acrylic acid, with an acrylic acid content of 10 wt. %; available from Honeywell™

Elvaloy® AC 34035 is a copolymer of ethylene and butyl acrylate, made with 35 wt. % butyl acrylate co-monomer content available from Dupont.

### Pigment

Cinquasia® Magenta D 4500 J, from BASF.

Ink jet Magenta E7B VP 3958 from Clariant.

### Polymeric Amine Dispersant

OS 13309, Solplus® P6000, Solsperse 13300, Solsparse® J560 and Solsperse® J561: all polymeric amine dispersants available from Lubrizol.

### Carrier Liquid

Isopar L™: an isoparaffinic oil comprising a mixture of C11-C13 isoalkanes; produced by Exxon Mobil™; CAS number 64742-48-9.

### Charge Adjuvant

VCA: an aluminium stearate; available from Fischer Scientific.

### Charge Director

NCD (natural charge director): KT (natural soya lecithin in phospholipids and fatty acids), BBP (basic barium petronate, i.e., a barium sulfonate salt of a 21-26 carbon hydrocarbon alkyl, available from Cemtura™), and GT (dodecyl benzene sulfonic acid isopropyl amine, supplied by Croda™). The composition being 6.6 wt. % KT, 9.8 wt. % BBP and 3.6 wt. % GT and balance (80 wt. %) Isopar L™.

### Additive

DS72: AEROSIL® R 7200: a hydrophobic fumed silica; available from Degussa AG.

### General Procedure—Preparation of the Electrostatic Ink

A paste was prepared by mixing the components of Table 1 below in a Heidolph homogenizer at 400 Hz for 1 hour:

TABLE 1

| Component | Amount (w/w) |
|---|---|
| Quinacridone pigment | 20% |
| Polymeric amine dispersant | 8% |
| Isopar L | 72% |

A resin paste was by combining the components listed in Table 2 in an S1 reactor filled with metal grinding balls and an initial solids content of 40% in Isopar L.

TABLE 2

| Component | Amount (w/w) |
|---|---|
| Nucrel 699 | 58.2 |
| AC580 | 38.8 |
| Elvaloy 34035 | 3 |

The components were mixed at 250 rpm for 12 h at 57° C.

A magenta ink composition was then prepared by combining the pigment paste, resin paste and additional components listed in Table 3 to give a composition with the amounts indicated:

TABLE 3

| Component | Amount (g) |
|---|---|
| Resin paste | 1761.5 |
| Pigment (from Table 1) | 193.20 |
| Dispersant (from Table 1) | 77.28 |
| DS72 | 10.89 |
| VCA | 6.90 |
| Isopar L ™ | 250.3 |

The components were mixed at 250 rpm for 12 h at 57° C. in an S1 reactor filled with metal grinding balls at 30% NVS.

The concentrated ink was then diluted with Isopar L™ to form the magenta ink composition (2 wt. % NVS; the working ink dispersion). Fifteen minutes prior to testing, NCD solution was added to the working ink dispersion (2.6 mg/g of working ink dispersion; 5.4 wt. % NVS) to form the test ink.

### Tests

### Plating Test

To evaluate color change as a function of developed ink layer, the following procedure was followed. A printed sample was obtained by developing a certain Developed Mass per Area (DMA) in units of mg to square cm of ink on paper by placing the charged ink working dispersion in a cell of a conductivity meter device (cell depth 1 mm, ˜4 cm in diameter). A sheet of paper is put on top of the cell and a counter electrode placed on top of that. A voltage pulse of 8 seconds 1500V is applied, and the upper counter electrode removed so that the paper with the developed ink on it can be removed.

The color of the developed ink on the paper was tested using a X-rite spectrophotometer, with the results shown in Table 4.

Table 4 below shows the TBN of each of the polymeric amine dispersants tested as part of a magenta ink composition comprising the quinacridone pigment from Clariant, against the results of the colour checks performed.

TABLE 4

| | TBN | | | | | | |
|---|---|---|---|---|---|---|---|
| Dispersant | (mg KOH/g) | OD | L | a | b | Hue | Chroma |
| P6000 | >400 | 1.44 | 50.63 | 77.3 | −17.7 | −12.9 | 79.3 |
| J561 | 70-80 | 1.33 | 49.55 | 75.7 | −22.7 | −16.7 | 79.1 |
| Reference | N/A | 1.36 | 49.52 | 76.0 | −21.2 | −15.6 | 78.8 |
| (no | | | | | | | |
| dispersant) | | | | | | | |
| OS 133309 | 120 | 1.41 | 47.02 | 76.4 | −24.6 | −17.9 | 79.9 |
| J560 | 50 | 1.6 | 44.43 | 78.9 | −22.8 | −16.1 | 82.1 |
| 13300 | 200-250 | N/A | 50.5 | 77.9 | −19.3 | −13.9 | 80.3 |

It can be seen from Table 4 that there is a major change in Hue toward the red when the Clariant pigment is treated with the Solplus® P6000 dispersant. The same characteristics were seen also when treating the BASF Quinacridone pigment with the same dispersant.

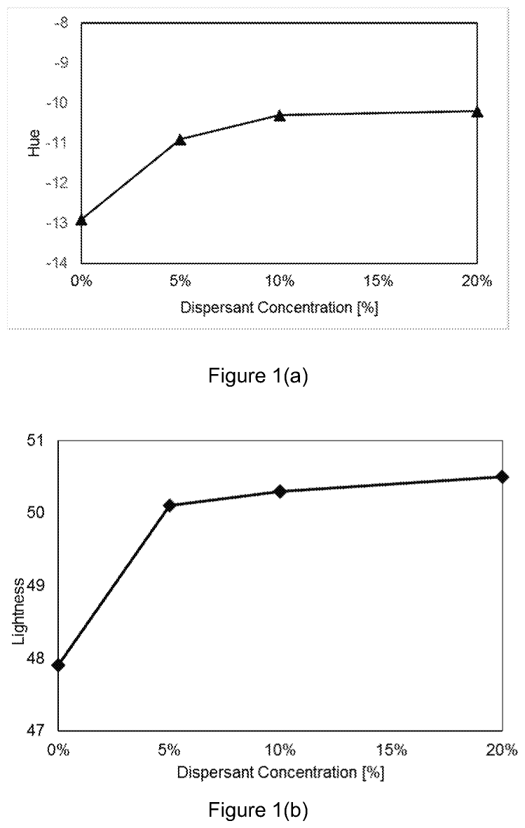

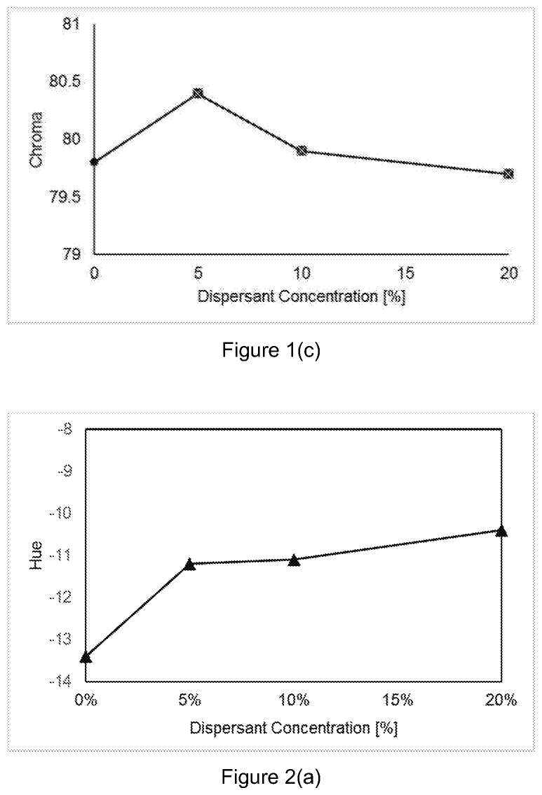

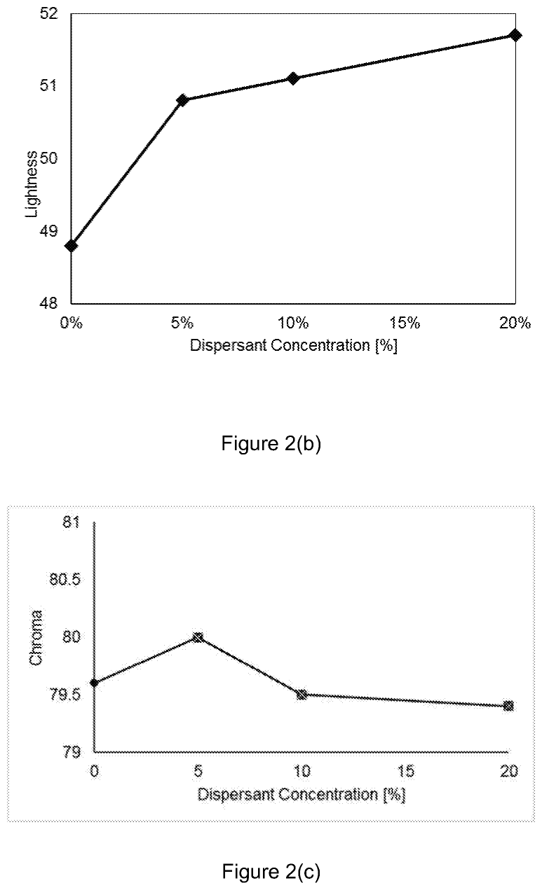

It was also investigated whether by reducing the dose of the dispersant this effect could still be achieved, with the results shown in FIGS. 1(a) to (c) (Ink jet Magenta E7B VP 3958) and FIGS. 2(a) to (c) (Cinquasia® Magenta D 4500 J).

It is shown that even at 5% AOWP, 4 times smaller than the dosage examined initially, there is still a change in the Hue angle toward the red. The increase in Lightness is also seen in the much smaller dosage although there is some reduction in both color coordinates. As seen before, no effect on Chroma is seen.

It can therefore be seen that use of a highly basic polymeric amine dispersant in combination with quinacridone pigments increases the color gamut and opens up red pantones not previously available with these pigments.

1. A magenta ink composition, comprising:
a pigment, wherein the pigment consists of one or more quinacridone pigments;
a resin; and
a polymeric amine dispersant having a Total Base Number of at least 300 mg KOH/gram.

2. A magenta ink composition according to claim 1, wherein the pigment consists of 5,12-dihydro-quino[2,3-b]acridine-7,14-dione, 2,9-dichloroquinacridone, 2,9-dimethylquinacridone or a combination thereof.

3. A magenta ink composition according to claim 1, wherein the polymeric amine dispersant is present in an amount of from 5 to 20% agent on weight pigment (AOWP).

4. A magenta ink composition according to claim 1, wherein the polymeric amine dispersant comprises a polyester.

5. A magenta ink composition according to claim 1, wherein the polymeric amine dispersant comprises a polyester and an amine anchor group.

6. A magenta ink composition according to claim 1, wherein the polymeric amine dispersant comprises pendant stearic acid groups.

7. A magenta ink composition according to claim 1, wherein the polymeric amine dispersant has a TBN of 400 mg/KOH.

8. A magenta ink composition according to claim 1, wherein the resin comprises a copolymer of an alkylene monomer and a (meth)acrylic acid monomer.

9. A magenta ink composition according to claim 1, wherein the resin comprises:
a first resin comprising a copolymer of an alkylene monomer and a methacrylic acid monomer;
a second resin comprising a copolymer of an alkylene monomer and an acrylic acid monomer; and
a third resin comprising a copolymer of an alkylene monomer and an alkyl (meth)acrylate monomer.

10. A magenta ink composition according to claim 9, wherein the ratio of the first resin to the second resin to the third resin is from 50:40:10 to 64:34:1.

11. A magenta ink composition according to claim 1, wherein the resin comprises a copolymer of ethylene and methacrylic acid, a copolymer of ethylene and acrylic acid, and a copolymer of ethylene and butyl acrylate.

12. A magenta ink composition according to claim 1, wherein the composition further comprises a carrier liquid.

13. A magenta ink composition according to claim 1, wherein the polymeric amine dispersant comprises from 0.01 wt. % to 10 wt. % of the total solids of the ink composition

14. A method of printing, comprising:
applying a magenta ink composition to a substrate, wherein the ink composition comprises:
a pigment, wherein the pigment consists of one or more quinacridone pigments;
a resin; and
a polymeric amine dispersant having a Total Base Number of at least 300 mg KOH/gram.

15. A printed substrate comprising
a substrate; and
a printed magenta ink composition disposed on the substrate;
wherein the printed magenta ink composition comprises:
a pigment, wherein the pigment consists of one or more quinacridone pigments;
a resin; and
a polymeric amine dispersant having a Total Base Number of at least 300 mg KOH/gram.
